(19) United States
(12) Patent Application Publication
(10) Pub. No.: US 2025/0125550 A1
(43) Pub. Date: Apr. 17, 2025

(54) TERMINAL FITTING

(71) Applicant: SUMITOMO WIRING SYSTEMS, LTD., Mie (JP)

(72) Inventor: Takuya OSHITA, Mie (JP)

(21) Appl. No.: 18/908,106

(22) Filed: Oct. 7, 2024

(30) Foreign Application Priority Data
Oct. 13, 2023 (JP) 2023-177174

(51) Int. Cl. H01R 13/11

(52) U.S. Cl. CPC H01R 13/11

(57) ABSTRACT

A terminal fitting 10 is constituted of a conductive plate. The terminal fitting 10 includes a main body portion 11 that is formed in a tubular shape extending in a front-back direction and in which gaps G1, G2, and G3 are each formed between opposed wall portions, and a protruding wall 12 configured to cover the gaps G1, G2, and G3 from the front side.

### CROSS-REFERENCE TO RELATED APPLICATIONS

This application is based on and claims priority from Japanese Patent Application No. 2023-177174, filed on Oct. 13, 2023, with the Japan Patent Office, the disclosure of which is incorporated herein in its entirety by reference.

### TECHNICAL FIELD

The present disclosure relates to a terminal fitting.

### BACKGROUND

JP 2002-270269A discloses an electrical contact (terminal fitting) having a receptacle portion (main body portion) having a polygonal-tube shape. The polygonal-tube shape of the receptacle portion is formed by plate-shaped wall portions. JP 2015-050131A and JP 2015-095422A also disclose terminal fittings.

### SUMMARY

In the electrical contact disclosed in JP 2002-270269A, the receptacle portion includes a part in which the wall portions overlap each other in the thickness direction. For example, if an electrical contact having such a configuration is inserted into a through hole of an integrated rubber plug, there is a concern that a portion of the integrated rubber plug enters a gap between the wall portions, resulting in damage to the through hole. If the configuration as described above in which a gap is formed between the wall portions is employed, there is also a concern that not only the integrated rubber plug but also, for example, a housing or the like is damaged, and it is required to suppress damage to an attachment target.

Therefore, it is an object of the present disclosure to provide a terminal fitting capable of suppressing damage to an attachment target.

A terminal fitting of the present disclosure is a terminal fitting constituted of a conductive plate, including: a main body portion that is formed in a tubular shape extending in a front-back direction and in which a gap is formed between opposed wall portions, and a protruding wall configured to cover the gap from a front side.

With the present disclosure, it is possible to provide a terminal fitting capable of suppressing damage to an attachment target.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a side cross-sectional view showing a connector that includes a terminal fitting of Embodiment 1.

FIG. 2 is a perspective view showing the terminal fitting.

FIG. 3 is a front view showing the terminal fitting.

FIG. 4 is a side cross-sectional view showing the terminal fitting.

FIG. 5 is a side cross-sectional view showing a process of inserting a front end portion of the terminal fitting through a through hole of an integrated rubber plug.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF THE PRESENT DISCLOSURE

First, aspects of the present disclosure will be listed and described.
(1) A terminal fitting constituted of a conductive plate, including: a main body portion that is formed in a tubular shape extending in a front-back direction and in which a gap is formed between opposed wall portions, and a protruding wall configured to cover the gap from a front side.

With the terminal fitting of aspect (1), the protruding wall covers the gap in the main body portion from the front side, and therefore, a portion of an attachment target is prevented from entering the gap, thus making it possible to suppress damage to the attachment target.
(2) The terminal fitting according to aspect (1), wherein a thickness direction of the protruding wall extends in the front-back direction, and the protruding wall protrudes forward by the thickness of the plate from the main body portion.

With the terminal fitting of aspect (2), it is possible to more reliably cover the gap formed in the main body portion. In addition, the terminal fitting has a configuration in which the protruding wall is added to the existing main body portion, and thus the protruding wall can be easily added.
(3) The terminal fitting according to aspect (1), wherein the main body portion has a quadrilateral tube shape and includes a pair of side walls, an upper wall, a lower wall, and a side gap that is formed at a portion where an end portion of one side wall of the pair of side walls and an end portion of the upper wall are opposed to each other and that is open to a lateral side, and the protruding wall includes a portion configured to cover the side gap from a front side.

A portion of the attachment target is likely to enter the side gap, and thus the attachment target is likely to be damaged. Therefore, with the terminal fitting of aspect (3), it is significantly advantageous to provide the protruding wall configured to cover the side gap from the front side.

### DETAILS OF EMBODIMENTS OF THE PRESENT DISCLOSURE

### Embodiment 1

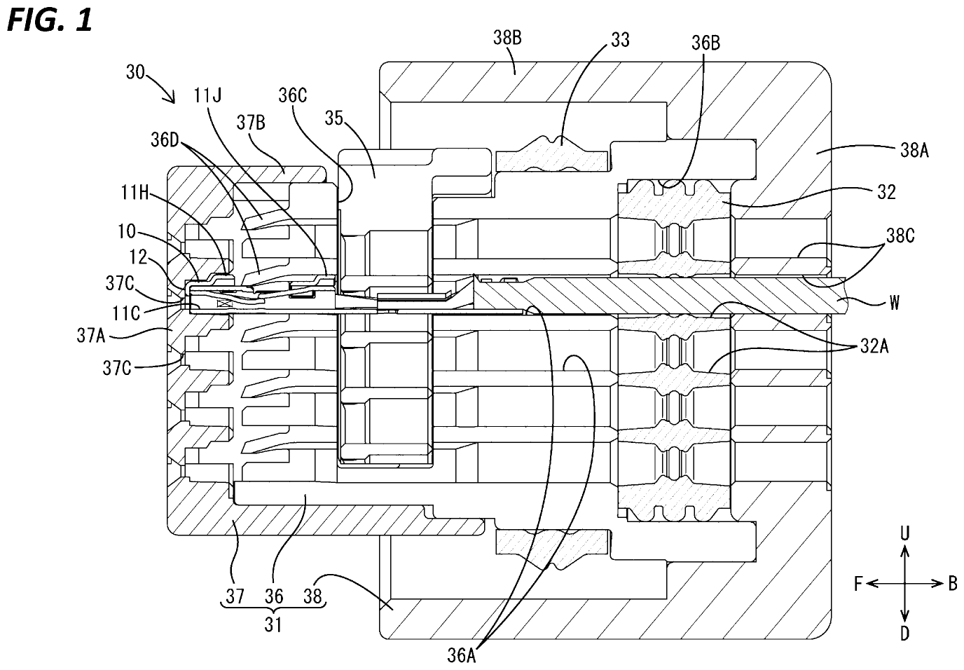

The following describes Embodiment 1 in which a connector 30 that includes a terminal fitting 10 of the present disclosure is embodied, with reference to FIGS. 1 to 5. In the diagrams, the “front side”, the “back side”, the “upside”, the “downside”, the “right side”, and the “left side” are represented by “F”, “B”, “U”, “D”, “R”, and “L”, respectively. Note that the reference directions are defined as a matter of convenience, and these directions do not necessarily coincide with the corresponding directions when the connector 30 that includes the terminal fitting 10 is mounted on a vehicle or the like. For example, the up-down direction is not limited to the gravity direction.

The connector 30 can be fitted to a counterpart connector (not illustrated). The counterpart connector includes a counterpart housing (not illustrated) and a counterpart terminal fitting (not illustrated). The counterpart terminal fitting is a male terminal fitting and includes a tab formed in a rod shape.

As shown in FIG. 1, the connector 30 includes a housing 31, an integrated rubber plug 32, a sealing ring 33, a retainer 35, and a plurality of terminal fittings 10. In FIG. 1, only one terminal fitting 10 is shown.

### [Configuration of Housing]

The housing 31 is formed by assembling an inner housing 36 made of a synthetic resin, an outer housing 38 made of a synthetic resin, and a front member 37 made of a synthetic resin that is attached to the front end portion of the inner housing 36.

### [Configuration of Inner Housing]

A plurality of cavities 36A are formed inside the inner housing 36. The terminal fittings 10 are inserted into the cavities 36A from the back side. A plurality of lances 36D that extend forward in the form of a cantilever are provided at the front end portion of the inner housing 36. The lances 36D are disposed to correspond to the cavities 36A. The lances 36D are each locked to, from the back side, a first locking protrusion 11H that is a locking protrusion of the terminal fitting 10 when the terminal fitting 10 is located at a proper position inside the cavity 36A. In order to accommodate the integrated rubber plug 32, the back end portion of the inner housing 36 is provided with an accommodation recessed portion 36B in the form in which the back surface thereof is recessed forward. The back ends of the cavities 36A are all open to the accommodation recessed portion 36B. A retainer attachment hole 36C that is open upward and is in communication with the cavities 36A is formed at the central portion of the inner housing 36 in the front-back direction.

### [Configuration of Outer Housing]

The outer housing 38 is attached to the inner housing 36 from the back side. The outer housing 38 includes a back wall 38A, and a tubular portion 38B that extends forward from the outer peripheral edge of the back wall 38A. The back wall 38A is provided with a plurality of insertion holes 38C that pass therethrough in the front-back direction. The insertion holes 38C are formed to correspond to the cavities 36A. The insertion holes 38C serve as paths through which the terminal fittings 10 pass when being inserted into the cavities 36A. Electric wires W fixed to the back end portions of the terminal fittings 10 are inserted through the insertion holes 38C.

### [Configuration of Front Member]

The front member 37 is attached to the inner housing 36 from the front side. The front member 37 includes an opposed wall 37A, and a cover portion 37B that has a tubular shape and extends backward from the outer peripheral edge of the opposed wall 37A. The opposed wall 37A is provided with a plurality of insertion holes 37C that pass therethrough in the front-back direction. The tabs of the counterpart terminal fittings (not illustrated) to be connected to the terminal fittings 10 are to be inserted into the insertion holes 37C from the front side.

### [Configuration of Integrated Rubber Plug]

The integrated rubber plug 32 is made of, for example, rubber such as silicone rubber. The integrated rubber plug 32 is accommodated in the accommodation recessed portion 36B of the inner housing 36. The outer peripheral edge of the integrated rubber plug 32 is in intimate contact with the inner periphery of the accommodation recessed portion 36B in a liquid-tight manner. The integrated rubber plug 32 is provided with a plurality of through holes 32A that pass therethrough in the front-back direction and correspond to the cavities 36A. The through holes 32A serve as paths through which the terminal fittings 10 pass when being inserted into the cavities 36A. The electric wires W are inserted through the through holes 32A in a liquid-tight manner.

### [Configuration of Sealing Ring]

The sealing ring 33 is made of, for example, rubber such as silicone rubber. The sealing ring 33 has an annular shape and is attached to the outer peripheral surface of the inner housing 36. The sealing ring 33 is attached thereto from the front side of the inner housing 36, and the front member 37 and the retainer 35 located at a final locking position prevent the sealing ring 33 from moving forward. When the counterpart connector (not illustrated) is connected to the connector 30, the sealing ring 33 comes into intimate contact with the inner periphery of a hood formed on the counterpart connector, in a liquid-tight manner.

### [Configuration of Retainer]

The retainer 35 is made of, for example, a synthetic resin. The retainer 35 has a plate shape and is inserted into the retainer attachment hole 36C of the inner housing 36 from the upper side. The retainer 35 can be moved relative to the inner housing 36 between the temporary locking position and the final locking position. The retainer 35 located at the final locking position is locked to second locking protrusions 11J provided at the back end portions of main body portions 11 of the terminal fittings 10, from the back side. The retainer 35 located at the final locking position prevents the dislodgement of the terminal fittings 10. When the retainer 35 is located at the temporary locking position, the state in which the retainer 35 is locked to the second locking protrusions 11J is released, and the state in which the retainer 35 prevents the dislodgement of the terminal fittings 10 is released.

### [Configuration of Terminal Fitting]

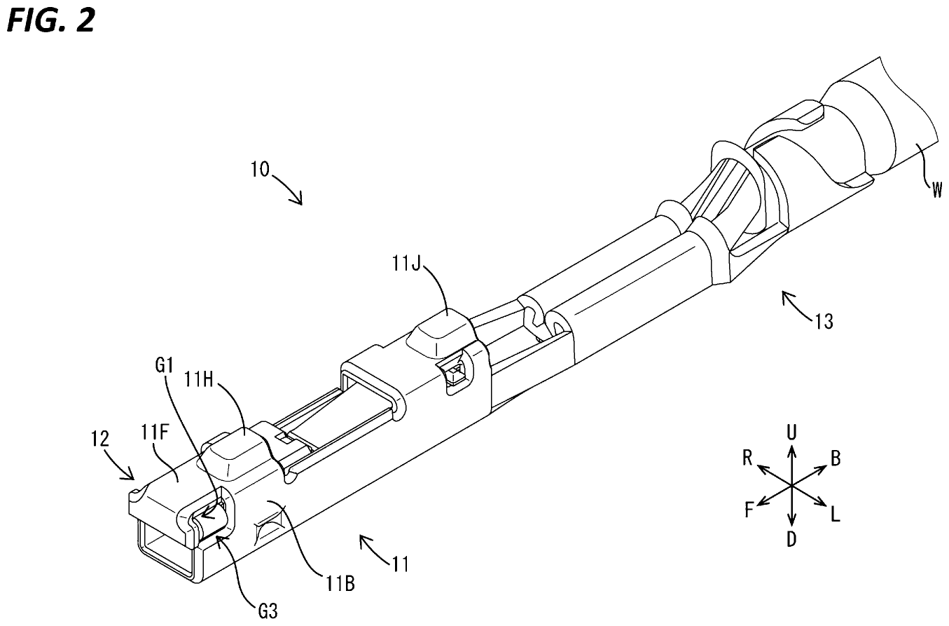

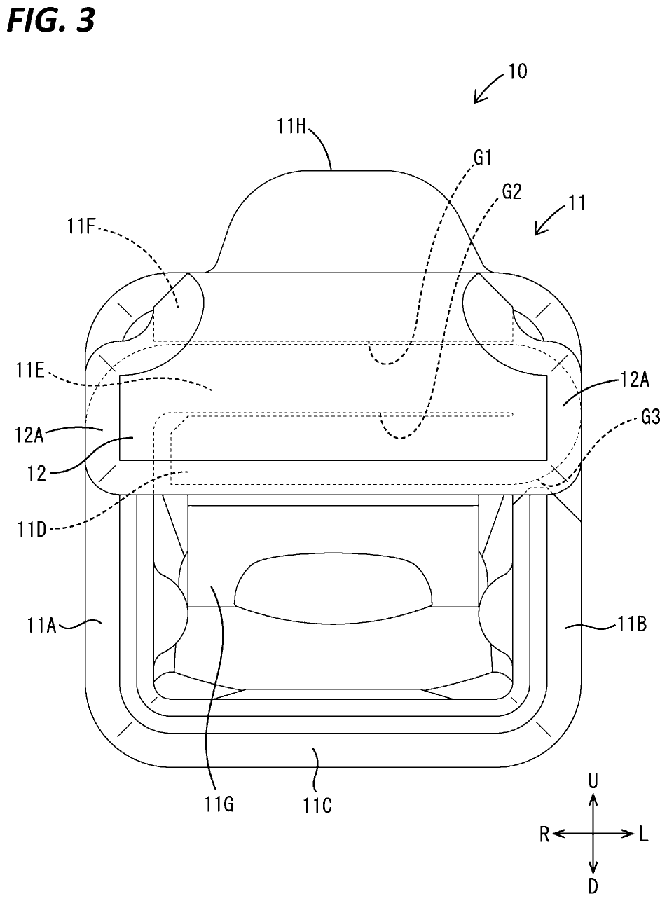

The terminal fittings 10 are each formed by pressing a conductive metal plate. As shown in FIG. 2, the terminal fitting 10 is a female terminal fitting and includes a main body portion 11 formed in a quadrilateral tube shape, a protruding wall 12, and a barrel portion 13. The main body portion 11 is arranged to extend in the front-back direction, and the front and back ends thereof are open. As shown in FIG. 3, the main body portion 11 includes a pair of side walls, namely a right side wall 11A and a left side wall 11B, a lower wall 11C, and upper walls, namely an inner wall 11D, a middle wall 11E, and an outer wall 11F. The right side wall 11A, the left side wall 11B, the lower wall 11C, the inner wall 11D, the middle wall 11E, and the outer wall 11F are wall portions that form the main body portion 11. The right side wall 11A and the left side wall 11B are spaced apart in the left-right direction with their thickness directions extending in the left-right direction. The lower wall 11C is continuous with the lower edges of the right side wall 11A and the left side wall 11B with the thickness direction extending in the up-down direction.

The thickness directions of the inner wall 11D, the middle wall 11E, and the outer wall 11F extend in the up-down direction. The middle wall 11E is stacked on top of the inner wall 11D, and the outer wall 11F is stacked on top of the middle wall 11E. In other words, the middle wall 11E is located between the inner wall 11D and the outer wall 11F. The inner wall 11D is spaced apart from the lower wall 11C and is located above the lower wall 11C. In other words, the inner wall 11D, the middle wall 11E, and the outer wall 11F are located in the upper portion of the main body portion 11 and are stacked in the interior-exterior direction.

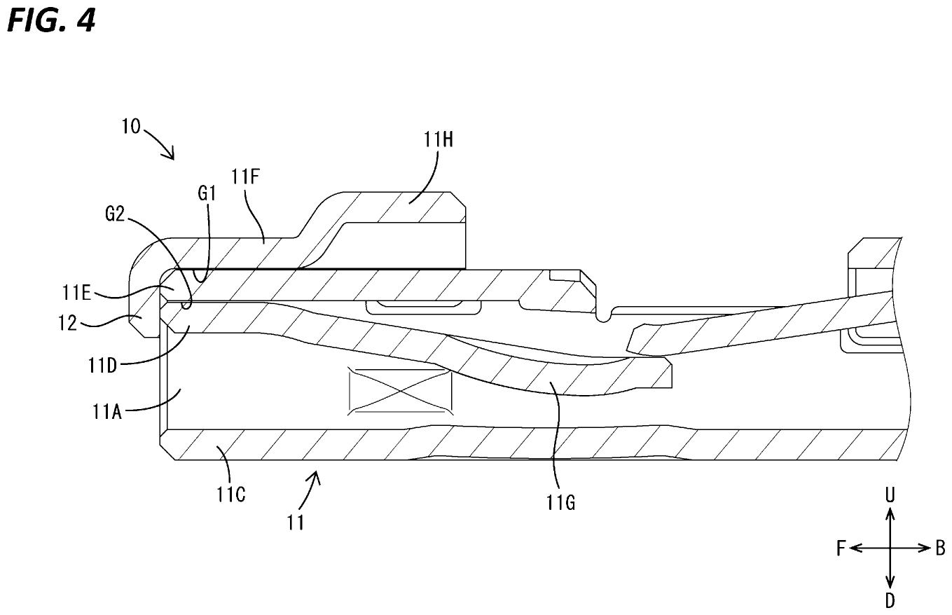

The right edge of the middle wall 11E is continuous with the upper edge of the right side wall 11A. The middle wall 11E is formed by being bent at the upper edge of the right side wall 11A so as to extend in parallel with the lower wall 11C. The left edge of the inner wall 11D is continuous with the left edge of the middle wall 11E. The inner wall 11D is formed by being folded back at the left edge of the middle wall 11E so as to extend in parallel with the lower wall 11C. The back portion of the inner wall 11D is formed as an elastic contact portion 11G that extends backward in the form of a cantilever while being inclined downward (see FIG. 4). The elastic contact portion 11G is elastically deformable in the up-down direction with its front end portion being a base point.

The left edge of the outer wall 11F is continuous with the upper edge of the left side wall 11B (see FIG. 2). The outer wall 11F is formed by being bent at the upper edge of the left side wall 11B so as to cover the middle wall 11E from the upper side. The back portion of the outer wall 11F is formed as a first locking protrusion 11H protruding upward (see FIG. 2). The left side wall 11B extends perpendicularly to the inner wall 11D with a side gap G3 therebetween.

The main body portion 11 includes a gap G1 between the middle wall 11E and the outer wall 11F. The main body portion 11 includes a gap G2 between the middle wall 11E and the inner wall 11D. The main body portion 11 includes a side gap G3 that is a gap formed at a portion where the upper end portion of the left side wall 11B and the left end portion of the inner wall 11D (upper wall) are opposed to each other. The side gap G3 is open toward the left side and the front side of the main body portion 11 (see FIG. 2). When the terminal fitting 10 is viewed from the front side, the side gap G3 is formed between the left side wall 11B and the inner wall 11D. The side gap G3 is also referred to merely as a “gap G3” hereinafter. That is to say, in the main body portion 11, the gaps G1, G2, and G3 are each formed between the opposed wall portions.

The protruding wall 12 is continuous with the front end of the outer wall 11F (see FIGS. 2 and 4). The protruding wall 12 is formed by being bent in a curved shape at the front edge of the outer wall 11F so as to cover the front end portion of the main body portion 11 from the front side (see FIG. 4). The thickness direction of the protruding wall 12 extends in the front-back direction. The protruding wall 12 protrudes forward by the single plate thickness from the main body portion 11 (see FIG. 4). The protruding wall 12 includes a pair of left and right protruding portions 12A. These protruding portions 12A protrude outward in the left-right direction from the protruding wall 12. The lower end of the protruding wall 12 is spaced apart from the lower wall 11C in the up-down direction. The protruding wall 12 collectively covers, from the front side, the gap G1 between the middle wall 11E and the outer wall 11F, the gap G2 between the middle wall 11E and the inner wall 11D, and the side gap G3 between the inner wall 11D (upper wall) and the left side wall 11B. The side gap G3 is covered by the left protruding portion 12A from the front side. That is to say, the protruding wall 12 includes a portion (protruding portion 12A) configured to cover the side gap G3 from the front side.

The tab of the counterpart terminal fitting (not illustrated) is inserted into the main body portion 11 through an opening between the lower end of the protruding wall 12 and the upper surface of the lower wall 11C. The elastic contact portion 11G comes into contact with the tab while being elastically displaced.

The barrel portion 13 has an open-barrel shape, is continuous with the back end of the main body portion 11, and extends backward (see FIG. 2). The barrel portion 13 is crimped to the terminal portion of the electric wire W (see FIG. 2).

### [Example of Step of Attaching Terminal Fitting to Housing]

First, the connector 30 is assembled using the components other than the terminal fitting 10. At this time, the retainer 35 is located at the temporary locking position. Then, the terminal fitting 10 is arranged such that the protruding wall 12 is located at the front end and the electric wire W is drawn backward, is brought close to the housing 31 from the back side, and is then inserted into the insertion hole 38C of the outer housing 38 from the back side (see FIG. 1).

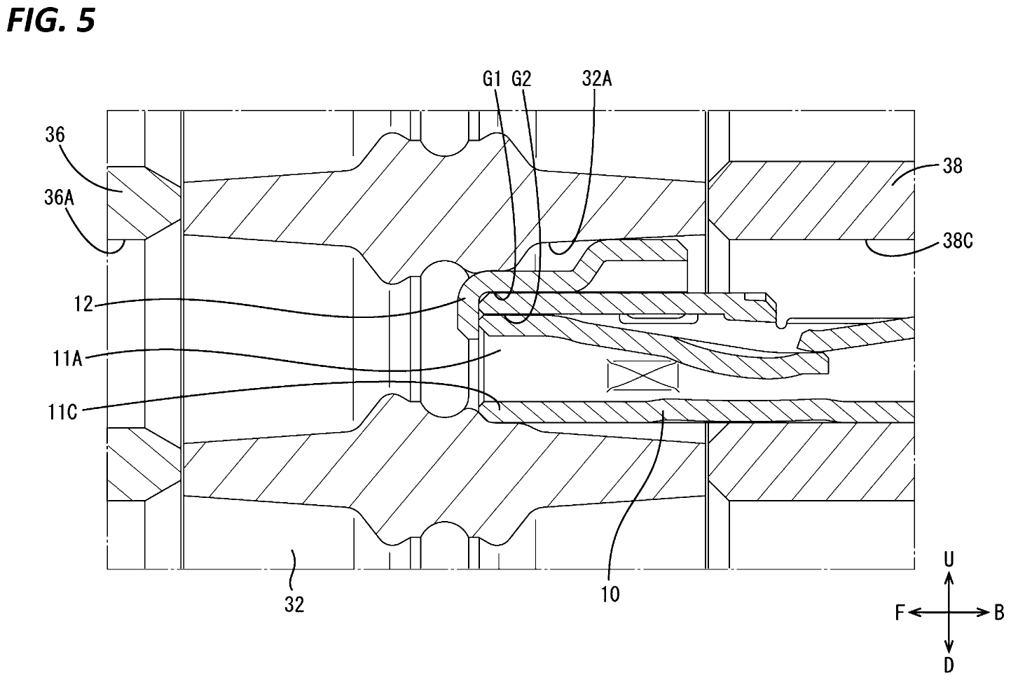

Next, the terminal fitting 10 is inserted into the through hole 32A of the integrated rubber plug 32 from the back side. Specifically, as shown in FIG. 5, first, the protruding wall 12, the right side wall 11A, the left side wall 11B, and the lower wall 11C of the terminal fitting 10 come into contact with the inner surface of the through hole 32A from the back side. The left side wall 11B is not illustrated in FIG. 5. Then, when the terminal fitting 10 is further inserted, the protruding wall 12, the right side wall 11A, the left side wall 11B, and the lower wall 11C press the inner surface such that the size of the through hole 32A is increased. Since the protruding wall 12 covers the gaps G1, G2, and G3 from the front side (see FIG. 3), these gaps remain to be away from the inner surface of the through hole 32A. The gap G3 is not illustrated in FIG. 5. It is thus possible to prevent the inner surface of the through hole 32A from being damaged due to the gaps G1, G2, and G3 in the terminal fitting 10.

Then, the terminal fitting 10 is moved forward through the through hole 32A of the integrated rubber plug 32 and is inserted into the cavity 36A of the inner housing 36 from the back side. The operation of inserting the terminal fitting 10 into the housing 31 is finished when the front surface of the protruding wall 12 of the terminal fitting 10 comes into contact with a portion above the insertion hole 37C on the back surface of the opposed wall 37A or when the front end of the lower wall 11C comes into contact with a portion below the insertion hole 37C on the back surface of the opposed wall 37A (see FIG. 1). At this time, the lance 36D is locked to the first locking protrusion 11H from the back side (see FIG. 1). Then, the retainer 35 is moved from the temporary locking position to the final locking position. Thus, the retainer 35 is locked to the second locking protrusion 11J from the back side. The assembly of the connector 30 is completed in this manner (see FIG. 1).

The following describes the effects of Embodiment 1.

The terminal fitting 10 is constituted of a conductive plate. The terminal fitting 10 includes the main body portion 11 that is formed in a tubular shape extending in the front-back direction and in which the gaps G1, G2, and G3 are each formed between the opposed wall portions, and the protruding wall 12 configured to cover the gaps G1, G2, and G3 from the front side. With this configuration, the protruding wall 12 covers the gaps G1, G2, and G3 in the main body portion 11 from the front side, and therefore, portions of the attachment target (integrated rubber plug 32) are prevented from entering the gaps G1, G2, and G3, thus making it possible to suppress damage to the attachment target.

The thickness direction of the protruding wall 12 extends in the front-back direction, and the protruding wall 12 protrudes forward by the single plate thickness from the main body portion 11. With this configuration, it is possible to more reliably cover the gaps G1, G2, and G3 formed in the main body portion 11. In addition, the terminal fitting 10 has a configuration in which the protruding wall 12 is added to the existing main body portion 11, and thus the protruding wall 12 can be easily added.

The main body portion 11 has a quadrilateral tube shape and includes the right side wall 11A, the left side wall 11B, the inner wall 11D (upper wall), the lower wall 11C, and the side gap G3 that is formed at a portion where the end portion of the left side wall 11B and the end portion of the inner wall 11D are opposed to each other and that is open to the left side. The protruding wall 12 includes a portion configured to cover the side gap G3 from the front side. A portion of the attachment target is likely to enter the side gap, and thus the attachment target is likely to be damaged. Therefore, with this configuration, it is significantly advantageous to provide the protruding wall configured to cover the side gap from the front side.

The protruding wall 12 is bent in a curved shape at the front end portion of the outer wall 11F and covers the front end portion of the main body portion 11 from the front side. With this configuration, a portion of the protruding wall 12 that is bent in a curved shape at the front end portion of the outer wall 11F can press the through hole 32A of the integrated rubber plug 32 to increase the diameter of the through hole 32A when the main body portion 11 is inserted into the through hole 32A, thus making it easy to insert the terminal fitting 10 into the through hole 32A.

The protruding wall 12 includes the pair of left and right protruding portions 12A that protrude outward in the left-right direction, and the left protruding portion 12A covers the gap G3 between the inner wall 11D and the left side wall 11B from the front side. With this configuration, the configuration is possible in which the protruding portions 12A covers the entire front end portion of the main body portion 11 in the left-right direction from the front side.

### Other Embodiments of the Present Disclosure

The embodiments disclosed herein are exemplary in all respects, and should be construed as being not limitative. The scope of the present invention is not limited to the embodiments disclosed herein and is defined by the scope of the appended claims, and all changes that fall within the same essential spirit as the scope of the claims are intended to be included therein.

Unlike the embodiment above, only one of the left and right protruding portions may be provided.

Unlike the embodiment above, one of the middle wall and the inner wall may be omitted.

Unlike the embodiment above, the main body portion may have a cylindrical shape.

Unlike the embodiment above, the left side wall may extend in a direction intersecting the inner wall. That is to say, the left side wall need not extend in a direction intersecting the inner wall at a right angle.

Unlike the embodiment above, a configuration may be employed in which a side gap that is open to the right side is formed at a portion where the end portion of the right side wall and the end portion of the inner wall are opposed to each other and the protruding wall covers this side gap from the front side.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A terminal fitting constituted of a conductive plate, comprising:
a main body portion that is formed in a tubular shape extending in a front-back direction and in which a gap is formed between opposed wall portions, and
a protruding wall configured to cover the gap from a front side.

2. The terminal fitting according to claim 1,
wherein a thickness direction of the protruding wall extends in the front-back direction, and the protruding wall protrudes forward by the thickness of the plate from the main body portion.

3. The terminal fitting according to claim 1,
wherein the main body portion has a quadrilateral tube shape and includes a pair of side walls, an upper wall, a lower wall, and a side gap that is formed at a portion where an end portion of one side wall of the pair of side walls and an end portion of the upper wall are opposed to each other and that is open to a lateral side, and
the protruding wall includes a portion configured to cover the side gap from a front side.
